(19) United States
(12) Patent Application Publication
(10) Pub. No.: US 2026/0303533 A1
(43) Pub. Date: Oct. 1, 2026

(54) Version Based Stateless Caching to Deliver Cloud Enforcement Policy to User Devices

(71) Applicant: Zscaler, Inc., San Jose, CA (US)

(72) Inventors: Ajit Singh, Mohali (IN); Ramneet Singh, Ontario (CA); Vivek Raman, San Jose, CA (US)

(73) Assignee: Zscaler, Inc., San Jose, CA (US)

(21) Appl. No.: 19/202,259

(22) Filed: May 8, 2025

(30) Foreign Application Priority Data
Mar. 26, 2025 (IN) 202541028417

(51) Int. Cl. H04L 47/125; H04L 67/1031; H04L 67/568

(52) U.S. Cl. CPC H04L 47/125; H04L 67/1031; H04L 67/568

(57) ABSTRACT

Systems and methods for version based stateless caching to deliver cloud enforcement policy to user devices include receiving keep-alive signals from a plurality of agent applications, each agent application of the plurality of agent applications being associated with and identifying a corresponding user device; storing device details associated with the plurality of agent applications; intercepting a policy request from at least one agent application of the plurality of agent applications; and responsive to determining device details associated with the at least one agent application are stored, returning a response to the at least one agent application from a policy cache.

### FIELD OF THE DISCLOSURE

The present disclosure generally relates to network and cloud security. More particularly, the present disclosure relates to systems and methods for version based stateless caching to deliver cloud enforcement policy to user devices.

### BACKGROUND OF THE DISCLOSURE

As more organizations migrate to cloud-based infrastructures, the number of deployed agent applications, each requiring frequent updates and policy checks, has escalated dramatically. This surge in demand has severely strained mobile administration (MA) systems, introducing performance bottlenecks and diminishing user experience. Existing approaches, such as lengthening polling intervals, temporarily alleviate server load but compromise timely responses and updates. Therefore, there is a clear need for a more efficient, scalable mechanism that can handle large-scale agent communications without sacrificing performance or user satisfaction. The present invention addresses these challenges by introducing a stateless reverse proxy architecture with robust caching mechanisms that optimizes communication between agent applications and the MA system, mitigating bottlenecks and enhancing overall responsiveness.

### BRIEF SUMMARY OF THE DISCLOSURE

The present disclosure relates to systems and methods for version based stateless caching to deliver cloud enforcement policy to user devices. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving keep-alive signals from a plurality of agent applications, each agent application of the plurality of agent applications being associated with and identifying a corresponding user device; storing device details associated with the plurality of agent applications; intercepting a policy request from at least one agent application of the plurality of agent applications; and responsive to determining device details associated with the at least one agent application are stored, returning a response to the at least one agent application from a policy cache.

The steps can further include determining whether policy information associated with the policy request is stored in the policy cache, and responsive to the policy information being stored, returning a response to the agent application from the policy cache. The steps can include determining whether the policy information in the policy cache is expired prior to the returning. The steps can include determining whether policy information associated with the policy request is stored in a policy cache, and responsive to the policy information not being stored and or is expired, forwarding the policy request to a mobile admin system and storing resulting policy information in the policy cache for subsequent use. The steps can be performed by a stateless cluster of reverse proxies adapted to intercept traffic between a plurality of user devices and a mobile admin system of a cloud-based system. The steps can include deploying a stateless cluster of reverse proxies, each reverse proxy including a device cache for storing device details and mappings of devices to policies, a policy cache for storing policy information, and a token cache for storing token information and mappings of tokens to policies. The steps can include batching, by the stateless cluster of reverse proxies, the keep-alive signals for subsequent forwarding to the mobile admin system over a persistent connection. The stateless cluster of reverse proxies can reduce load on the mobile admin system by batching keep-alive signals, caching policy information, and serving repeated requests without re-querying the mobile admin system. Each reverse proxy in the stateless cluster can be configured to automatically scale up or down based on traffic load, thereby maintaining performance during varying demand levels in the cloud-based system. The steps can include monitoring performance metrics of the stateless cluster of reverse proxies, including cache hit rates, response times, and load distribution, and adjusting cache configurations or scaling parameters based on the monitored metrics.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a Mobile Admin (MA) system operating within a cloud-based system.

FIG. 6 is a flow diagram of an optimized cloud enforcement policy delivery system utilizing a Mobile Admin Gateway (MAG).

FIG. 7 is a flowchart of a process for optimized cloud enforcement policy delivery.

### DETAILED DESCRIPTION OF THE DISCLOSURE

Again, the present disclosure relates to systems and methods for version based stateless caching to deliver cloud enforcement policy to user devices. That is, the present invention includes a stateless cluster of reverse proxies, referred to as a Mobile Admin Gateway (MAG), that intercepts and manages requests from millions of agent applications to a central Mobile Administration (MA) system in a cloud environment. By caching device details, token information, and policy data, the MAG significantly reduces repetitive queries to the MA system. It batches keep-alive signals to minimize overhead and serves repeated policy or token requests directly from its caches. This architecture ensures lower load on the MA system, faster response times for end users, and improved scalability and reliability in handling high volumes of traffic.

### § 1.0 Cybersecurity Monitoring and Protection Examples

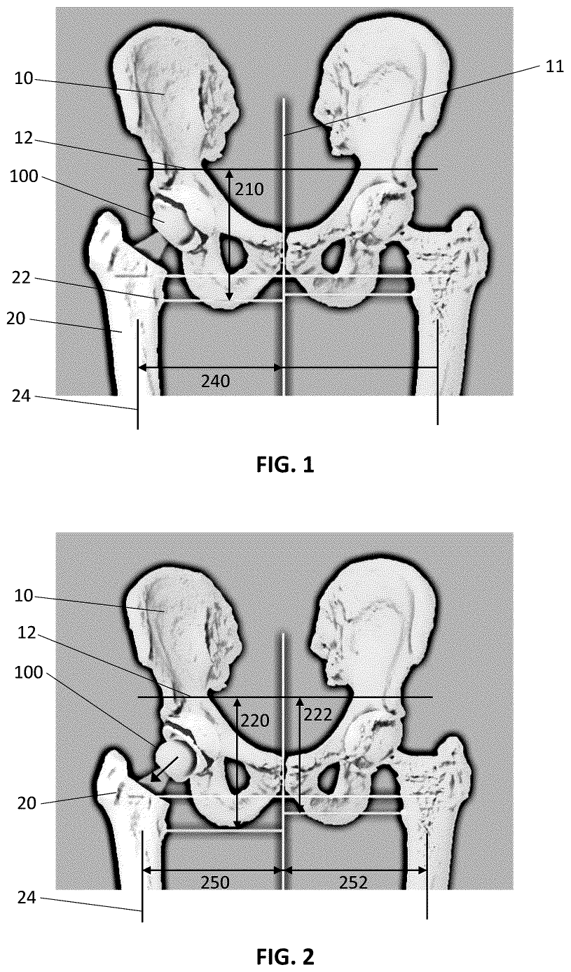

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

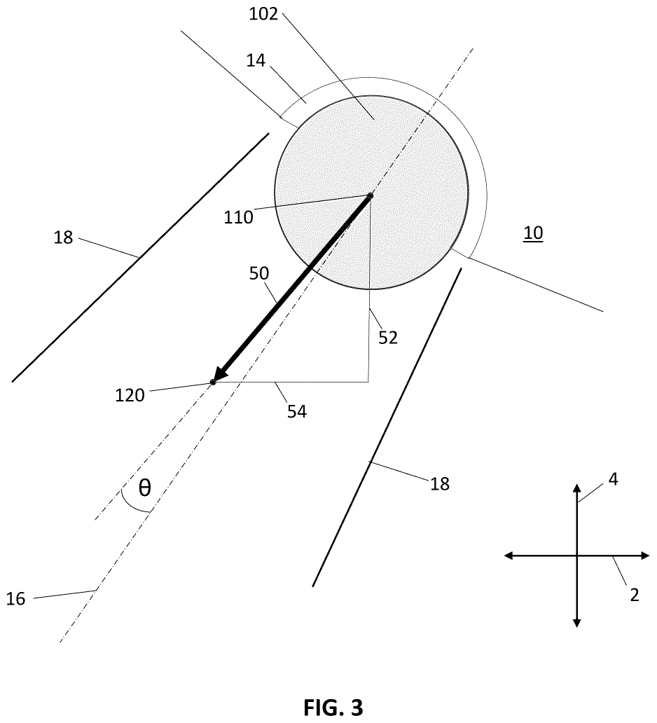

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

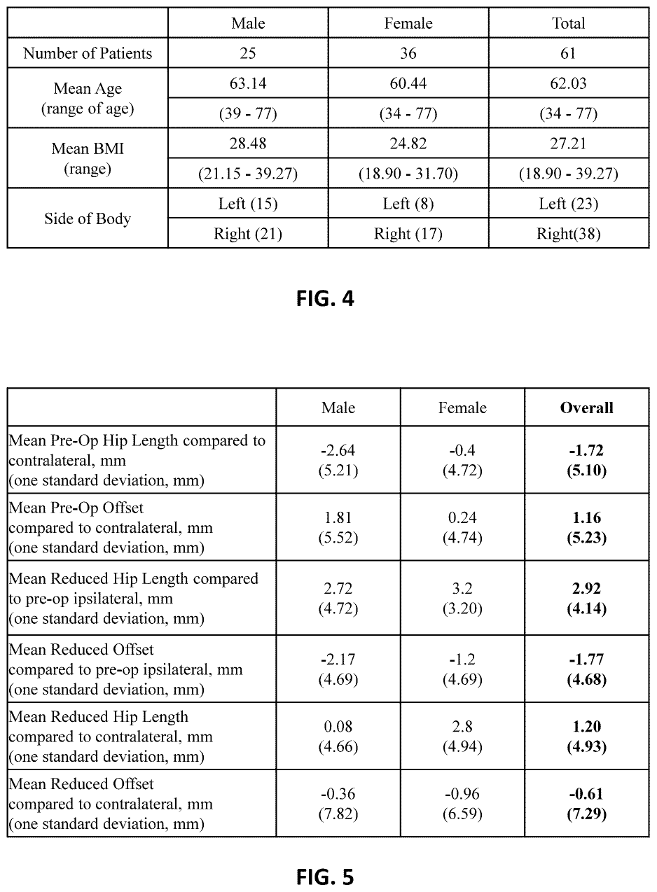

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Mobile Admin Cloud Enforcement Policy Delivery

In various embodiments, a Mobile Admin (MA) is a central component within the cloud-based system, i.e., the cloud 120, that is responsible for managing and coordinating the interactions between millions of deployed agent applications 110 and the administrative services. The MA plays a critical role in ensuring that devices and their associated applications operate smoothly and securely within the network.

FIG. 5 is a flow diagram of an MA 502 operating within a cloud-based system 120. The key functions of the MA 502 include policy management, device management, authentication and authorization, data aggregation and reporting, and serving as a communication hub. In terms of policy management, the MA 502 is responsible for downloading and distributing security policies to the agent applications 110. These policies dictate how the agent applications 110 should behave, what resources they can access, and how they should handle various network activities, ensuring that all devices are compliant with the latest security protocols and configurations.

For device management, the MA 502 keeps track of all the devices that have agent applications 110 installed, monitoring their status, connectivity, and compliance with security policies. It also handles the registration and deregistration of devices within the network. In terms of authentication and authorization, the MA 502 manages these processes for devices and users, ensuring that only authorized entities can access certain services and data by validating tokens and credentials to verify identity and permissions.

The MA 502 also plays a vital role in data aggregation and reporting by collecting and aggregating data from the agent applications 110 about their activities, usage patterns, and security incidents. It provides detailed reports and analytics to administrators for monitoring the health and security posture of the network. As a communication hub, the MA 502 facilitates the exchange of information, policy updates, and status reports between the agent applications 110 and the administrative services, ensuring that communication is secure, reliable, and efficient.

However, as the number of deployed agent applications 110 increases, the MA 502 can become overloaded due to the high volume of interactions and data it needs to process. This overload can lead to performance bottlenecks, increased latency, and a degraded user experience. To address these challenges, a Mobile Admin Gateway (MAG) is introduced. The MAG acts as an intermediary that offloads some of the processing tasks from the MA 502. By implementing caching mechanisms and reverse proxy architecture, MAG reduces the direct load on the MA 502, ensuring that it can handle the increased demand without compromising performance. The MAG caches device details, token information, and policies, allowing it to respond to many requests locally without involving the MA. This strategic offloading helps maintain a scalable, efficient, and responsive system, even as the number of agent applications 110 continues to grow.

In summary, the MA 502 is a crucial component that manages policies, devices, authentication, and data aggregation within the cloud infrastructure, while the MAG supports it by offloading tasks and enhancing performance through caching and efficient data handling.

### § 6.0 Optimized Cloud Enforcement Policy Delivery

As an increasing number of users transition to cloud-based systems, we are observing a significant surge in the deployment of millions of agent applications 110 worldwide. This widespread adoption has placed an overwhelming burden on the MA system, causing it to become a critical bottleneck in the clouds infrastructure. Traditionally, to alleviate this excessive load, methods included extending the polling intervals for the periodic Application Programing Interfaces (APIs) of these agent applications 110. While this method does help in reducing the immediate strain on the MA system, it inadvertently results in a deteriorated user experience. The longer polling intervals mean that end users have to endure extended wait times to receive updates, which can be frustrating and diminish their overall satisfaction with cloud services. Consequently, it is imperative to explore and implement more innovative solutions that can effectively manage the increasing load on the MA system without compromising the timely delivery of updates and the overall user experience.

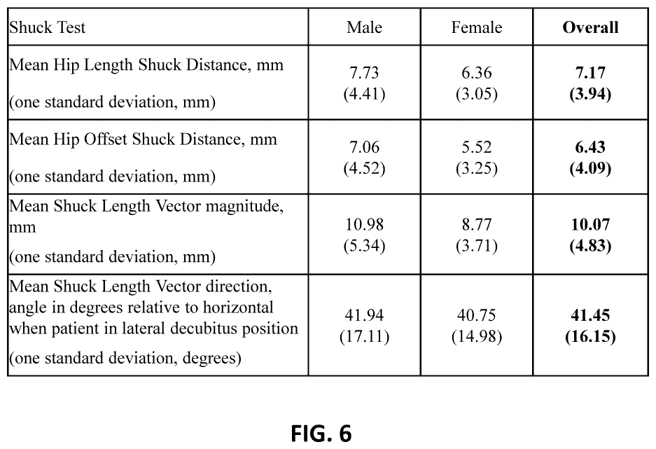

FIG. 6 is a flow diagram of an optimized cloud enforcement policy delivery system utilizing a MAG 504 (MAG cluster). Again, the MA 502, augmented by the MAG 504, is designed to efficiently manage and streamline the interaction between millions of deployed agent applications 110 and the central administrative services of the cloud 120. The core components and functions work cohesively to ensure optimal performance and user experience. Agent applications 110, which are, as described herein, agent applications deployed on user devices, regularly communicate with the MA system 502 to report status, fetch policies, and request updates. They send periodic signals, known as keep-alives, to indicate their active and functioning status.

The MAG 504 acts as a stateless cluster of reverse proxies that intercept and manage communication between agent applications 110 and the MA 502. It employs various caching mechanisms to store device details, token information, and policy data, which helps reduce the load on the MA 502 and improve response times.

Key processes within this system include handling keep-alive signals and managing policies. Agent applications 110 send keep-alive signals to the MAG 504, which stores these signals and the corresponding device details in the device cache. This cache maps each device to its respective policies, allowing MAG 504 to serve responses to agent applications 110 from the cache and reducing the need for frequent direct queries to the MA 502. The MAG 504 batches these keep-alive signals and forwards them to the MA 502 over a persistent connection, further reducing the number of individual requests the MA 502 has to handle.

For policy management, when agent applications 110 request policy updates, the MAG 504 inspects these requests and stores the relevant policy information in the policy cache. Subsequent policy requests are then served directly from the policy cache, bypassing the MA 502 and thus reducing both load and response time. Similarly, when agent applications 110 request policies using tokens, the MAG 504 inspects the requests, stores the token details in the token cache, and maps them to the relevant policies.

The API support provided by MAG 504 includes the keepalive API, which manages keep-alive signals from agent applications, ensuring that device status and details are efficiently cached and updated. The policy download API handles policy download requests, caching the policies to serve future requests quickly. The token policy fetch API manages token-based policy requests by caching the token details and associated policies. For any other API requests that do not fall under these categories, the MAG 504 is adapted to pass them through to the MA 502 without caching.

The benefits of MAG 504 are substantial. Being stateless, MAG 504 can scale up or down based on the load, providing flexibility and maintaining performance during varying traffic levels. By caching device details, token information, and policies, MAG 504 significantly reduces the number of direct interactions with the MA 502, alleviating bottlenecks and ensuring smoother operations. The caching mechanisms ensure that repeated requests for the same information are served quickly from the cache, enhancing the end-user experience by reducing wait times for updates. Additionally, MAG 504 acts as a shock absorber, protecting the central administrative system from sudden surges in demand, thereby maintaining stability and reliability.

More specifically, the functions performed by the MAG 504 include the following:

Keepalive API: The MAG 504 caches keep-alives from agent applications 110, which means it stores the periodic signals sent by the agent applications 110 to indicate active status. It serves these cached responses directly to the agent applications 110, ensuring quick and efficient communication without overloading the MA 502. Additionally, the MAG 504 forwards batched keep-alives to the MA 502 over a persistent connection, reducing the frequency and volume of direct interactions with the MA 502.

Policy Download API: By inspecting the keep-alive signals and policy download requests from agent applications 110, the MAG 504 learns which policies are of interest. Once these policies are identified, all subsequent policy downloads are served directly from the cache, significantly reducing the load on the MA 502 and speeding up response times for the end-users.

Token Policy Fetch API: The MAG 504 inspects the traffic to learn policies from token policy requests made by agent applications 110. Similar to the Policy Download API, once the policies are identified and cached, all subsequent token policy downloads are served from the cache, enhancing efficiency and reducing strain on the MA 502.

Any Other API: For any other API requests that do not fall under the aforementioned categories, the MAG 504 can pass them through to the MA 502 without caching. This ensures that all necessary requests are handled appropriately, maintaining the integrity and functionality of the system.

By offloading these functions to the MAG, the Mobile Admin experiences a significant reduction in direct traffic and workload, allowing it to operate more smoothly and efficiently. This strategic distribution of tasks not only improves response times for end-users but also ensures that the system remains robust and capable of handling surges in demand without compromising performance.

Additionally, implementations of the MAG 504 include the utilization of various caches to optimize performance and reduce the load on the MA 502. These caches are strategically designed to store and manage essential data, thereby improving response times and ensuring seamless operation. The primary caches implemented are:

Device Cache: The Device Cache stores detailed information about devices interacting with the system. This cache is populated through the keep-alive API, which provides regular updates about the status and details of each device. By mapping devices to their respective policies, the Device Cache ensures that the relevant policy information is readily available. This mapping allows for quick retrieval of policy details when a device makes a request.

Token Cache: The Token Cache is dedicated to storing token details, which are critical for authentication and authorization processes within the system. This cache is populated through the fetch token policy API, which extracts and stores the necessary token information. Similar to the Device Cache, the Token Cache maps tokens to their corresponding policies. This mapping facilitates efficient policy retrieval, ensuring that subsequent token-related requests can be swiftly served from the cache.

Policy Cache: The Policy Cache is responsible for storing detailed policy information. This cache is populated through the policy download API, which gathers and stores the various policies that devices and tokens require. By maintaining a comprehensive repository of policies, the Policy Cache ensures that any future requests for policy information can be quickly fulfilled from the cache. This reduces the frequency of direct interactions with the MA 502, thereby enhancing system efficiency and reducing load.

Collectively, these caches work in coordination to streamline data retrieval processes and improve overall system performance. By ensuring that critical details about devices, tokens, and policies are readily available, the caches help maintain a high level of responsiveness and reliability within the system. This implementation not only enhances the user experience by reducing wait times for updates and responses but also ensures that the underlying infrastructure remains robust and capable of handling high volumes of traffic efficiently.

To facilitate the efficient functioning of the MAG 504 in the cloud 120, several critical steps are undertaken to ensure the system is scalable, responsive, and capable of managing high volumes of traffic while maintaining optimal performance.

Firstly, the deployment of the MAG 504 cluster involves provisioning the infrastructure by deploying a stateless cluster of MAG 504 instances using cloud infrastructure services. This process includes setting up virtual machines or containers that can scale based on the load. Additionally, the configuration of reverse proxies within the MAG 504 cluster is essential to intercept and manage communication between agent applications 110 and the MA 502.

Next, the implementation of caching mechanisms is essential. For the Device Cache setup, the integration with the keep-alive API is necessary to store device details received from the keep-alive signals. Configuring the cache to map each device to its respective policies ensures quick retrieval. The Token Cache setup requires integration with the token policy fetch API to capture and store token details, mapping tokens to their corresponding policies for efficient access. The Policy Cache setup involves integrating with the policy download API to store policy details, configuring the cache for quick access to policy information, thus reducing the need for repeated queries to the MA 502.

API management is another critical aspect. For the keepalive API, caching keep-alive signals from agent applications 110 and serving responses from the cache to agent applications 110 is vital. Implementing batch processing to forward keep-alives to the MA 502 over a persistent connection is also crucial. For the Policy Download API, setting up the MAG 504 to learn policies by inspecting keep-alive and policy download requests from agent applications 110 and ensuring that subsequent policy download requests are served from the cache is essential. Similarly, for the Token Policy Fetch API, capturing policy details from token-based requests and storing them in the cache, and ensuring that all subsequent token policy requests are served directly from the cache is necessary.

Scalability and load management are achieved through auto-scaling configuration, which involves setting up auto-scaling policies to dynamically adjust the number of MAG 504 instances based on traffic and load conditions. Implementing load balancing to distribute incoming requests evenly across the MAG 504 instances ensures no single instance is overwhelmed.

Monitoring and maintenance are ensured by implementing performance monitoring tools to track the performance and health of the MAG 504 instances, including cache hit rates, response times, and load metrics. Regular updates and maintenance tasks are scheduled to ensure the MAG 504 instances are running the latest software versions and security patches. Admins can also configure redundancy and failover mechanisms to maintain service continuity in case of instance failures.

Security measures include ensuring that all data in transit between agent applications 110, MAG 504, and MA 502 is encrypted using secure protocols. Implementing strict access control policies to restrict unauthorized access to the MAG 504 and its caches is also performed. Additionally, regular security audits are conducted to identify and mitigate potential vulnerabilities.

By following these steps, the MAG 504 can be effectively deployed and managed in the cloud 120, providing a robust and scalable solution that enhances the performance of the MA system 502 while delivering a superior user experience.

From the perspective of the MAG, several key steps are performed to ensure efficient management of interactions between millions of agent applications 110 and the central administrative services of the cloud 120.

Firstly, in handling keep-alive signals, the MAG 504 receives periodic keep-alive signals from agent applications 110, indicating that they are active and functioning properly. These signals, along with the corresponding device details, are stored in the Device Cache. By serving responses directly from the Device Cache, MAG 504 reduces the need for frequent direct queries to the MA 502. Additionally, MAG 504 batches these keep-alive signals and forwards them to the MA 502 over a persistent connection, further minimizing the number of individual requests the MA 502 has to handle.

In an embodiment, the MAG 504 is adapted to, based on a keep-alive request from an agent application 110, determine if the device associated with the agent application is in the cache. If it is not, the MAG 504 forwards the keep-alive request to the MA 502. If it is, the MAG 504 will put the keep-alive request in a batch queue. Based thereon, the MAG 504 will generate a keep-alive response for the agent application 110.

In managing policy requests, when agent applications 110 request policy updates, MAG 504 inspects these requests to learn the policies of interest. The relevant policy information is then stored in the Policy Cache, ensuring that subsequent requests for these policies can be served from the cache. For all subsequent policy download requests from agent applications 110, MAG 504 serves the data directly from the Policy Cache.

When handling token policy requests, MAG 504 inspects the token policy requests made by agent applications 110. The token details and the corresponding policies are stored in the Token Cache. All subsequent token policy requests from agent applications 110 are served directly from the Token Cache.

In various embodiments, responsive to a policy request, the MAG 504 is adapted to determine if the device is in its cache. If it is not, the MAG 504 can forward the policy request to the MA 502. If it is, the MAG 504 then determined is the policy is in its cache. If not, the MAG 504 can forward the policy request to the MA 502. If it is, the MAG 504 determines if the policy is expired. If the policy is determined to be expired by the MAG 504 can forward the policy request to the MA 502. If the policy is not expired, the MAG 504 will generate a policy response for the agent application 110 which provided the request.

In terms of API support, MAG 504 manages keep-alive signals from agent applications 110 through the Keepalive API, ensuring that device status and details are efficiently cached and updated. The Policy Download API handles policy download requests, caching the policies to serve future requests quickly. The Token Policy Fetch API manages token-based policy requests by caching the token details and associated policies.

In terms of monitoring and maintenance, MAG 504 implements performance monitoring tools to track the performance and health of its instances, including cache hit rates, response times, and load metrics. Further, MAG 504 undergoes regular updates and maintenance to ensure it runs the latest software versions and security patches. It is configured with redundancy and failover mechanisms to maintain service continuity in case of instance failures.

In conclusion, the MA system 502 of the cloud 120, enhanced by the MAG 504, efficiently manages the interaction between millions of agent applications and the central administration services. By leveraging caching and a reverse proxy architecture, the system reduces the load on the MA 502, improves response times, and ensures scalability and reliability. This results in a robust and efficient infrastructure capable of handling high volumes of traffic while providing a seamless experience for end users.

### § 6.1 Process for Optimized Cloud Enforcement Policy Delivery

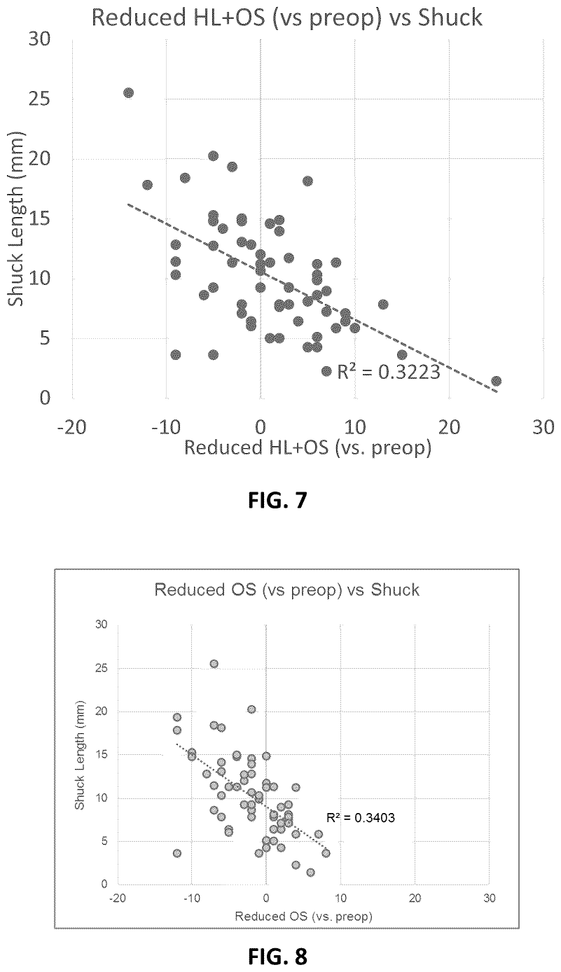

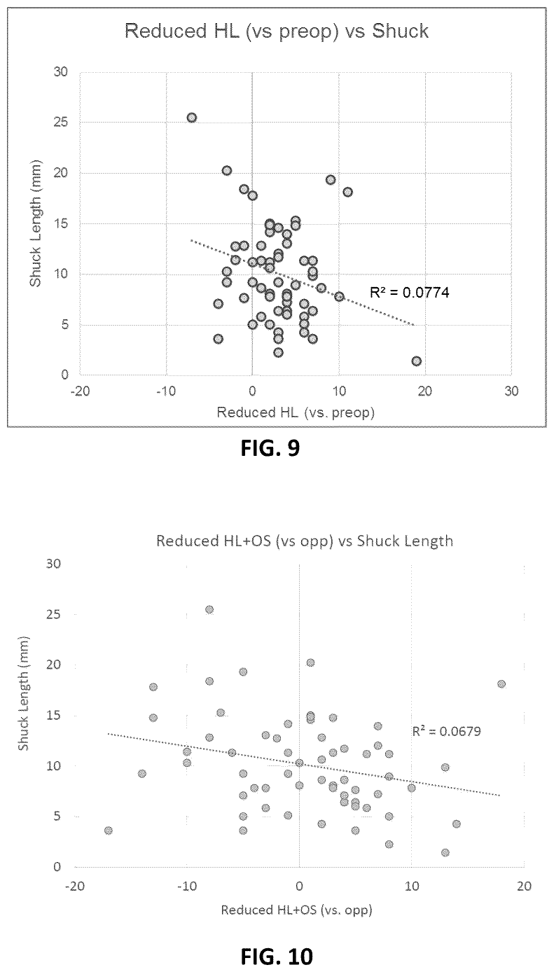

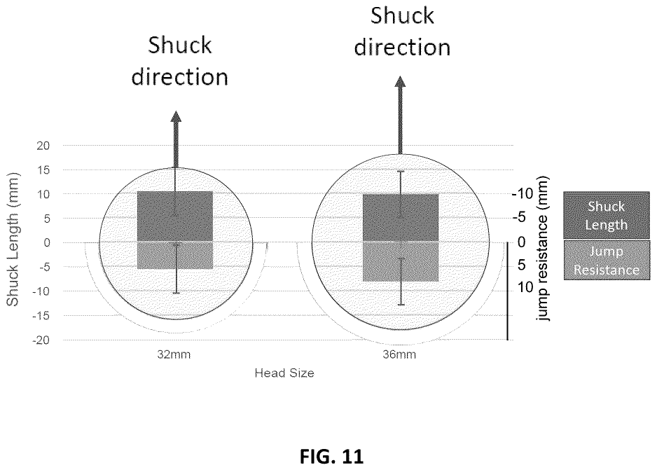

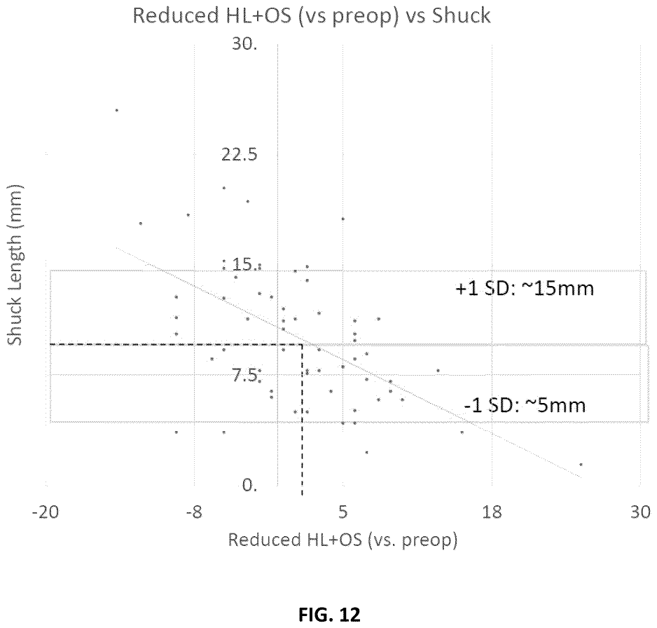

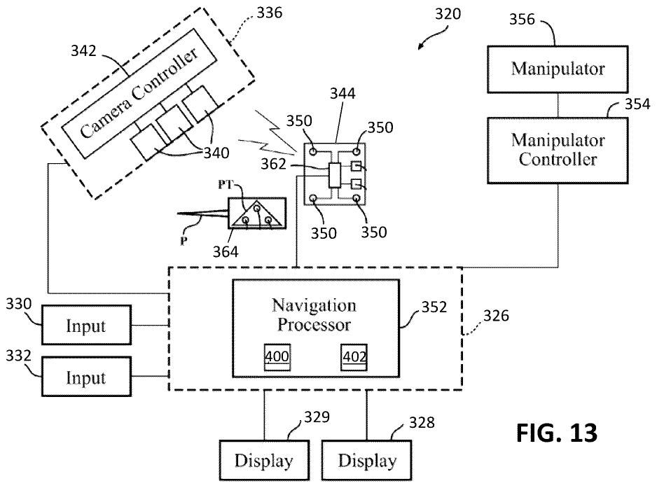

FIG. 7 is a flowchart of a process 700 for optimized cloud enforcement policy delivery. In various embodiments, the process 700 can include a method having steps, a processing device configured to implement the steps, a cloud-based system configured to implement the steps, and as a non-transitory computer-readable medium storing instructions for programming one or more processors to execute the steps. The process 700 includes receiving keep-alive signals from a plurality of agent applications, each agent application of the plurality of agent applications being associated with and identifying a corresponding user device (step 702); storing device details associated with the plurality of agent applications (step 704); intercepting a policy request from at least one agent application of the plurality of agent applications (step 706); and responsive to determining device details associated with the at least one agent application are stored, returning a response to the at least one agent application from a policy cache (step 708).

The process 700 can further include determining whether policy information associated with the policy request is stored in the policy cache, and responsive to the policy information being stored, returning a response to the agent application from the policy cache. The steps can include determining whether the policy information in the policy cache is expired prior to the returning. The steps can include determining whether policy information associated with the policy request is stored in a policy cache, and responsive to the policy information not being stored and or is expired, forwarding the policy request to a mobile admin system and storing resulting policy information in the policy cache for subsequent use. The steps can be performed by a stateless cluster of reverse proxies adapted to intercept traffic between a plurality of user devices and a mobile admin system of a cloud-based system. The steps can include deploying a stateless cluster of reverse proxies, each reverse proxy including a device cache for storing device details and mappings of devices to policies, a policy cache for storing policy information, and a token cache for storing token information and mappings of tokens to policies. The steps can include batching, by the stateless cluster of reverse proxies, the keep-alive signals for subsequent forwarding to the mobile admin system over a persistent connection. The stateless cluster of reverse proxies can reduce load on the mobile admin system by batching keep-alive signals, caching policy information, and serving repeated requests without re-querying the mobile admin system. Each reverse proxy in the stateless cluster can be configured to automatically scale up or down based on traffic load, thereby maintaining performance during varying demand levels in the cloud-based system. The steps can include monitoring performance metrics of the stateless cluster of reverse proxies, including cache hit rates, response times, and load distribution, and adjusting cache configurations or scaling parameters based on the monitored metrics.

### § 7.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 8.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method for delivering cloud enforcement policy to user devices from a cloud-based system, the method comprising steps of:
receiving keep-alive signals from a plurality of agent applications, each agent application of the plurality of agent applications being associated with and identifying a corresponding user device;
storing device details associated with the plurality of agent applications;
intercepting a policy request from at least one agent application of the plurality of agent applications; and
responsive to determining device details associated with the at least one agent application are stored, returning a response to the at least one agent application from a policy cache.

2. The method of claim 1, wherein the steps comprise determining whether policy information associated with the policy request is stored in the policy cache, and responsive to the policy information being stored, returning a response to the agent application from the policy cache.

3. The method of claim 2, wherein the steps further comprise determining whether the policy information in the policy cache is expired prior to the returning.

4. The method of claim 1, wherein the steps comprise determining whether policy information associated with the policy request is stored in a policy cache, and responsive to the policy information not being stored and or is expired, forwarding the policy request to a mobile admin system and storing resulting policy information in the policy cache for subsequent use.

5. The method of claim 1, wherein the steps are performed by a stateless cluster of reverse proxies adapted to intercept traffic between a plurality of user devices and a mobile admin system of a cloud-based system.

6. The method of claim 5, wherein the steps comprise deploying a stateless cluster of reverse proxies, each reverse proxy including a device cache for storing device details and mappings of devices to policies, a policy cache for storing policy information, and a token cache for storing token information and mappings of tokens to policies.

7. The method of claim 5, wherein the steps include batching, by the stateless cluster of reverse proxies, the keep-alive signals for subsequent forwarding to the mobile admin system over a persistent connection.

8. The method of claim 5, wherein the stateless cluster of reverse proxies reduces load on the mobile admin system by batching keep-alive signals, caching policy information, and serving repeated requests without re-querying the mobile admin system.

9. The method of claim 5, wherein each reverse proxy in the stateless cluster is configured to automatically scale up or down based on traffic load, thereby maintaining performance during varying demand levels in the cloud-based system.

10. The method of claim 5, wherein the steps comprise monitoring performance metrics of the stateless cluster of reverse proxies, including cache hit rates, response times, and load distribution, and adjusting cache configurations or scaling parameters based on the monitored metrics.

11. A non-transitory computer-readable medium comprising instructions for delivering cloud enforcement policy to user devices from a cloud-based system that, when executed, cause one or more processors to perform steps of:
receiving keep-alive signals from a plurality of agent applications, each agent application of the plurality of agent applications being associated with and identifying a corresponding user device;
storing device details associated with the plurality of agent applications;
intercepting a policy request from at least one agent application of the plurality of agent applications; and
responsive to determining device details associated with the at least one agent application are stored, returning a response to the at least one agent application from a policy cache.

12. The non-transitory computer-readable medium of claim 11, wherein the steps comprise determining whether policy information associated with the policy request is stored in the policy cache, and responsive to the policy information being stored, returning a response to the agent application from the policy cache.

13. The non-transitory computer-readable medium of claim 12, wherein the steps further comprise determining whether the policy information in the policy cache is expired prior to the returning.

14. The non-transitory computer-readable medium of claim 11, wherein the steps comprise determining whether policy information associated with the policy request is stored in a policy cache, and responsive to the policy information not being stored and or is expired, forwarding the policy request to a mobile admin system and storing resulting policy information in the policy cache for subsequent use.

15. The non-transitory computer-readable medium of claim 11, wherein the steps are performed by a stateless cluster of reverse proxies adapted to intercept traffic between a plurality of user devices and a mobile admin system of a cloud-based system.

16. The non-transitory computer-readable medium of claim 15, wherein the steps comprise deploying a stateless cluster of reverse proxies, each reverse proxy including a device cache for storing device details and mappings of devices to policies, a policy cache for storing policy information, and a token cache for storing token information and mappings of tokens to policies.

17. The non-transitory computer-readable medium of claim 15, wherein the steps include batching, by the stateless cluster of reverse proxies, the keep-alive signals for subsequent forwarding to the mobile admin system over a persistent connection.

18. The non-transitory computer-readable medium of claim 15, wherein the stateless cluster of reverse proxies reduces load on the mobile admin system by batching keep-alive signals, caching policy information, and serving repeated requests without re-querying the mobile admin system.

19. The non-transitory computer-readable medium of claim 15, wherein each reverse proxy in the stateless cluster is configured to automatically scale up or down based on traffic load, thereby maintaining performance during varying demand levels in the cloud-based system.

20. The non-transitory computer-readable medium of claim 15, wherein the steps comprise monitoring performance metrics of the stateless cluster of reverse proxies, including cache hit rates, response times, and load distribution, and adjusting cache configurations or scaling parameters based on the monitored metrics.
